(19) United States
(12) Patent Application Publication
(10) Pub. No.: US 2025/0202293 A1
(43) Pub. Date: Jun. 19, 2025

(54) STATOR OF AN ELECTRIC ROTATING MACHINE, ELECTRIC ROTATING MACHINE, AND GEARED MOTOR UNIT

(71) Applicant: Schaeffler Technologies AG & Co. KG, Herzogenaurach (DE)

(72) Inventors: Daniel Schnabl, Bad Schönborn (DE); Dennis Kuhl, Bühl (DE)

(73) Assignee: Schaeffler Technologies AG & Co. KG, Herzogenaurach (DE)

(21) Appl. No.: 18/847,719

(22) PCT Filed: Mar. 14, 2023
(86) PCT No.: PCT/DE2023/100192

§ 371 Date: Sep. 17, 2024

(30) Foreign Application Priority Data
Mar. 18, 2022 (DE) 10 2022 106 345.3

(51) Int. Cl. H02K 1/14; H02K 3/18; H02K 7/116

(52) U.S. Cl. CPC H02K 1/14; H02K 3/18; H02K 7/116

(57) ABSTRACT

A stator of an electric rotating machine, an electric rotating machine equipped therewith and to a geared motor unit having the electric rotating machine. The stator of the electric rotating machine has a plurality of stator teeth, of which at least one stator tooth comprises a laminated core and on at least one side of the laminated core facing a rotor of an electric rotating machine comprising the stator, at least one pole shoe is arranged which delimits an air gap between the rotor and the stator tooth and is formed at least in regions from a soft-magnetic composite material. The pole shoe is bounded between its side facing the air gap and its side facing the laminated core on at least one side bounding the pole shoe along the circumferential direction by an obliquely extending surface and the cross-section of the pole shoe is larger on the side facing the air gap than on the side facing the laminated core.

### CROSS-REFERENCE TO RELATED APPLICATIONS

This application is the U.S. National Phase of PCT Appln. No. PCT/DE2023/100192 filed Mar. 14, 2023, which claims priority to DE 10 2022 106 345.3 filed Mar. 18, 2022, the entire disclosures of which are incorporated by reference herein.

### TECHNICAL FIELD

The disclosure relates to a stator of an electric rotating machine, an electric rotating machine equipped therewith and a geared motor unit having the electric rotating machine.

### BACKGROUND

Electric drive machines are known in many industrial applications from the prior art and are also increasingly being used in the automotive industry. Such a machine comprises a stator and a rotor rotatable in relation thereto. The rotor usually comprises a rotor shaft, balancing plates, laminated rotor cores, and magnets.

Particularly in the case of electrically powered motor vehicles, it is necessary to achieve the required performance in the available installation space. Accordingly, the electric rotating machine must be designed as a very axially compact radial flux machine, or as an axial flux machine. The required installation space for the power electronics associated with the respective electric rotating machine must also be taken into account.

In order to reduce iron losses in the stator, high-quality non-grain-oriented electrical sheets with very low sheet thicknesses are usually used. If the machine topology allows it, grain-oriented electrical sheets can also be used, which usually further minimize losses.

Such electrical sheets are often used in stator yokeless axial flux machines. Here, however, the guidance of the magnetic flux from the air gap into the stator tooth can also cause losses. In electric rotating machines with non-grain-oriented electrical sheets, funnel-shaped tooth geometries made of the same material as the electrical sheets are sometimes used. When using grain-oriented electrical sheets, pole shoes are used in some places, which are made of a soft-magnetic composite material and are arranged on the laminated core. The poorer properties of the soft-magnetic composite material with regard to flux guidance are accepted because the total losses resulting from a combination of grain-oriented electrical sheets and soft-magnetic composite material are lower than the formation of the laminated core from non-grain-oriented electrical sheets.

DE 10 2020 101 149 A1 discloses an axial flux machine, preferably for a drive train of a purely electric or hybrid motor vehicle, said axial flux machine comprising an annular stator and two rotor elements mounted rotatably relative to the stator about a common axis of rotation, wherein a first rotor element is arranged axially along the axis of rotation adjacent to a first axial end face of the stator and a second rotor element is arranged axially adjacent to a second axial end face of the stator, and wherein the stator has a plurality of stator cores distributed in a circumferential direction of a circular line extending about the axis of rotation. The stator cores have pole shoes arranged along the circumferential direction next to the laminated core.

DE 10 2015 223 766 A1 discloses an electric machine in the form of an axial flux motor, having a rotor mounted so as to be rotatable about a machine axis and a stator which has a sintered support structure and an insert connected thereto, which at least partially forms a pole shoe, and which comprises a laminated core.

### SUMMARY

On this basis, the object of the present disclosure is to provide a stator and an electric rotating machine equipped therewith, which ensure long-lasting operation with high efficiency in a simple structural design.

This object is achieved by the stator according to the disclosure described herein, and by the electric rotating machine described herein. Advantageous embodiments of the stator are described in the claims, description and drawings.

The features of the claims can be combined in any technically meaningful way, it also being possible to make reference for this purpose to the explanations from the following description and features from the figures which include supplementary developments of the disclosure.

The terms “axial”, “radial” and “in the circumferential direction” refer in the following to the axis of rotation of an electric rotating machine equipped with the stator.

The disclosure relates to a stator of an electric rotating machine, comprising a plurality of stator teeth, of which at least one stator tooth comprises a laminated core and, on at least one side of the laminated core facing a rotor of an electric rotating machine comprising the stator, at least one pole shoe is arranged which delimits the air gap between the rotor and the stator tooth and is formed at least in regions from a soft-magnetic composite material. The pole shoe is delimited between its side facing the air gap and its side facing the laminated core on at least one side delimiting the pole shoe along the circumferential direction by an obliquely extending surface, wherein the cross-section of the pole shoe is larger on the side facing the air gap than on the side facing the laminated core.

If necessary, the obliquely extending surface can have other shape elements to a minor extent, such as unevenness, so that it is substantially an obliquely extending surface.

The aforementioned cross-section is a section which runs parallel to the axis of rotation of a rotor of an electric rotating machine comprising the stator and perpendicular to the planes of the laminations of the laminated core when these are aligned substantially radially with respect to the axis of rotation. Insofar as the stator is designed for a stator yokeless arrangement of rotors of an axial flux machine—i.e., for a so-called H-arrangement—the stator tooth has two axially opposite sides.

Each stator tooth is formed from a laminated core and is separated from an adjacent stator tooth at the circumference by slots and windings placed in the slots. The pole shoe extends from the laminated core towards the air gap or the position of the rotor. In one embodiment, the pole shoe is therefore located exclusively between the air gap and the laminated core, and not along the circumferential direction next to the laminated core.

The pole shoe is a component made of a material with high permeability and serves to allow the magnetic field lines to emerge and distribute them in a defined shape.

According to the disclosure, the pole shoe geometry is optimized so that, in addition to optimal flux guidance, shielding from fields containing harmonies is also achieved.

In one embodiment of the stator, it is provided that the stator is the stator of an axial flux machine, so that the pole shoe is arranged on an axial side of the laminated core. The pole shoe is delimited between its side facing the air gap and its side facing the laminated core on at least one side radially delimiting the stator tooth by an obliquely extending surface, wherein the cross-section of the pole shoe is larger on the side facing the air gap than on the side facing the laminated core.

The cross-section referred to here runs in a section parallel to the axis of rotation of a rotor of an electric rotating machine comprising the stator and parallel to the planes of the laminations of the laminated core when these are aligned substantially radially with respect to the axis of rotation.

The laminations of the laminated core can be grain-oriented electrical sheets. This means that the electrical sheets are electrical sheets made from a grain-oriented iron material.

Alternatively, it is intended that the sheets of the laminated core are non-grain-oriented electrical sheets. This design enables an increase in efficiency in machine topologies that do not allow the use of grain-oriented electrical sheet.

An advantageous embodiment of the stator provides that the obliquely extending surface extends up to a maximum of 60% of the height of the pole shoe defined between the laminated core and the air gap. Accordingly, this embodiment of the stator provides that the pole shoe has, in addition to its respective obliquely extending surface, a further boundary surface which connects to the obliquely extending surface and which delimits the pole shoe along the circumferential direction or radially.

Furthermore, it can be provided that the obliquely extending surface extends to at least 40% of the height of the pole shoe defined between the laminated core and the air gap.

Furthermore, the stator can comprise at least one winding for each stator tooth, which wraps around the respective stator tooth, wherein the pole shoe forms at least one projection along the circumferential direction, which axially covers the winding in regions and extends along the circumferential direction to at least 50% of the maximum distance from the winding to the laminated core. This means that the projection extends towards the adjacent stator tooth.

In addition, the stator can comprise at least one winding for each stator tooth, which wraps around the respective stator tooth, wherein the pole shoe forms at least one projection along the circumferential direction, which axially covers the winding in regions and extends along the circumferential direction up to 100% of the maximum distance of the winding from the laminated core. The side of the projection facing the laminated core has an obliquely extending surface on at least one side.

The obliquely extending surface can be substantially connected to the laminated core. Minor deviations from this design, which result in a step between the obliquely extending surface and the outside of the laminated core, are insignificant in this embodiment. For example, in the case of pole shoes on both sides of the laminated core, the inner boundary edges of the obliquely extending surfaces in relation to the laminated core can have a distance from one another that corresponds to 90% to 110% of the width of the laminated core.

The stator according to the disclosure can be a stator of an axial flux machine, so that the pole shoe is arranged on an axial side of the laminated core. In this embodiment, it is accordingly provided that the pole shoe has an obliquely extending surface at least on one radially extending edge, the plane of which is oriented in addition to the general radial extension with a respective directional component in the circumferential direction, as well as in the axial direction, and is formed on the side facing the winding.

Furthermore, this pole shoe can also have such an obliquely extending surface on a radially delimiting side.

In an alternative embodiment, the stator is a stator of a radial flux machine, so that the pole shoe is arranged on a radial side of the laminated core.

Another aspect of the present disclosure is an electric rotating machine having a stator according to the present disclosure and a rotor which is arranged at the air gap opposite the stator. This electric rotating machine can be an axial flux machine or a radial flux machine. In the case of an axial flux machine, this can have a stator yokeless design—a so-called H-arrangement—in which the stator is arranged axially centrally and a rotor is arranged axially on both sides of the stator respectively in a rotatable manner.

By combining the pole shoe geometry according to the disclosure with the material technical division of the stator tooth into laminated core and pole shoe, the efficiency of the electric rotating machine equipped therewith can be increased, since the electrical sheet reduces the power losses and the magnetic resistance, but only allows one-dimensional flux guidance. The soft-magnetic composite material enables three-dimensional flux guidance with low eddy current losses, which are particularly dominant in fields with harmonics, and also allows more complex geometries in production.

Accordingly, the design of the pole shoe according to the disclosure reduces undesirable stray fluxes and, through its shielding effect, eliminates the main problem of the conventional two-part stator made of soft-magnetic composite material and electrical sheets.

The obliquely extending surface also provides surface area which enables additional convection at a thermally critical point during direct groove cooling.

The disclosure also provides a geared motor unit which has at least one electric rotating machine according to the disclosure and at least one transmission, whose transmission input shaft is or can be coupled to a rotor shaft of the electric rotating machine.

### BRIEF DESCRIPTION OF THE DRAWINGS

The disclosure described above is explained in detail below against the relevant technical background with reference to the associated drawings, which show embodiments. The disclosure is in no way limited by the purely schematic drawings and it should be noted that the exemplary embodiments shown in the drawings are not limited to the dimensions shown. In the figures:

FIG. 1: shows an electric rotating machine according to the disclosure in a partial sectional view from the side, and

FIG. 2: shows the electric rotating machine according to the disclosure in a further partial sectional view.

### DETAILED DESCRIPTION

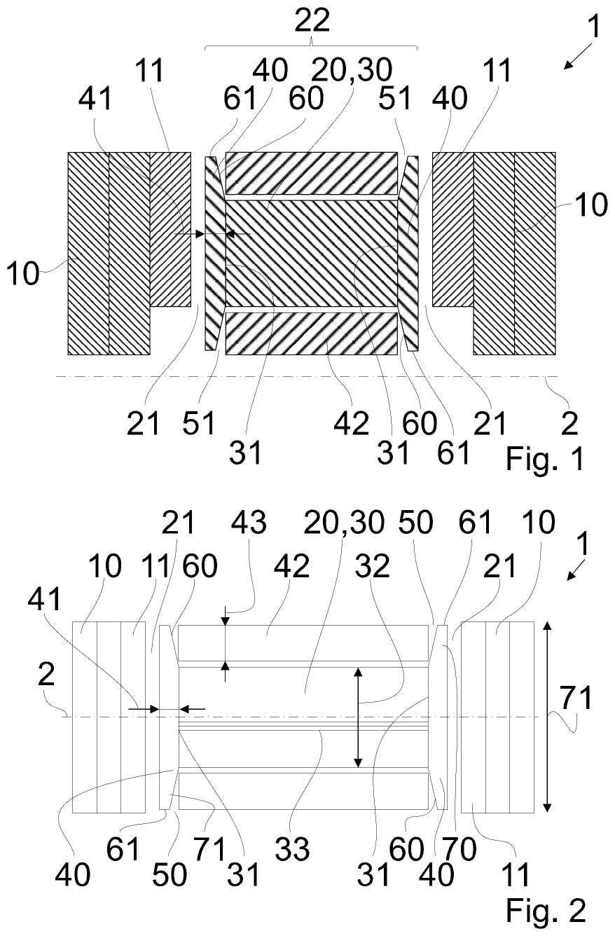

FIGS. 1 and 2 show an electric rotating machine 1 designed according to the disclosure in different views, wherein FIG. 1 shows a partial section of the electric rotating machine 1 above the axis of rotation, and FIG. 2 shows a partial section of the electric rotating machine 1 in a section that runs perpendicular to the section line of FIG. 1. In the following, the electric rotating machine 1 and its stator 20 are explained using the two FIGS. 1 and 2.

The electric rotating machine 1 shown here forms a stator-yokeless or so-called H-arrangement of the two rotors 10 arranged axially on both sides with respect to the stator 20. The magnets 11 of the two rotors 10 are each arranged opposite the stator 20, so that a respective air gap 21 is formed between a respective magnet 11 and the stator 20 or its respective pole shoe 40.

Only one stator tooth 22 of the stator 20 is shown in FIGS. 1 and 2.

The stator tooth 22 comprises a laminated core 30, which comprises several sheets 33 made of grain-oriented or non-grain-oriented iron material.

From FIG. 2, it can be seen that the individual sheets 33 are aligned substantially radially. The laminated core 30 is wrapped by at least one winding 42.

A pole shoe 40 made of a soft-magnetic composite material is fixed to each of the two axial sides 31 of the laminated core 30.

A respective pole shoe 40 has an obliquely extending surface 60 on its side 51 radially delimiting the stator tooth, as shown in FIG. 1, and on its side 50 delimiting the stator tooth along the circumferential direction 71, as shown in FIG. 2.

This obliquely extending surface 60 has the effect that a projection 70 present along the circumferential direction 71, as well as radially, and which is formed by the respective pole shoe 40, has a smaller cross-section on its outer side than in the region of fixation on the laminated core 30.

This allows the magnetic flux to be optimally guided into the winding 42 and into the laminated core 30, while at the same time shielding fields containing harmonics.

However, in the embodiment shown here, the obliquely extending surface 60 does not extend to the axial outer side of the relevant pole shoe 40, but rather ends at a certain distance in front of the axial outer side, so that the pole shoe 40 has a respective further boundary surface 61 on its radial outer side or on its radial inner side, as well as on its circumferentially delimiting side.

It is intended that the obliquely extending surface 60 extends up to a maximum of 60% of the height 41 of the pole shoe 40 defined between the laminated core 30 and the air gap 21.

As can be seen in particular from FIG. 2, the projection 70 of the pole shoe 40, which is delimited by the obliquely extending surface 60, extends approximately so far along the circumferential direction 71 that the adjacently arranged winding 42 is almost completely covered axially. In other words, this projection 70 extends approximately as far as the distance 43 from the winding 42 to the laminated core 30.

In addition, FIG. 2 shows that the obliquely extending surfaces 60, which are arranged on the sides 50 delimiting the stator tooth 22 along the circumferential direction 71, extend until they meet the laminated core 30. In other words, these two obliquely extending surfaces 60, which lie opposite one another along the circumferential direction 71, are separated from one another by a distance which corresponds to the width 32 of the laminated core 30.

The inventive design of the stator makes it possible to reduce magnetically induced power losses by approximately 10%.

Using the stator proposed here and the electric rotating machine equipped therewith, devices can be provided which, in a simple structural design, ensure long-lasting operation of the electric rotating machine with high efficiency.

### LIST OF REFERENCE SIGNS

1 Electric rotating machine
2 Axis of rotation
10 Rotor
11 Magnet
20 Stator
21 Air gap
22 Stator tooth
30 Laminated core
31 Axial side of the laminated core
32 Laminated core width
33 Lamination
40 Pole shoe
41 Pole shoe height
42 Winding
43 Distance from the winding to the laminated core
50 Side which delimits the stator tooth along the circumferential direction
51 Side which radially delimits the stator tooth
60 Obliquely extending surface
61 Further delimiting surface
70 Projection
71 Circumferential direction

1. A stator of an electric rotating machine, comprising:
a plurality of stator teeth, of which at least one stator tooth comprises a laminated core and, on at least one side of the laminated core facing a rotor of the electric rotating machine comprising the stator, at least one pole shoe is arranged which delimits an air gap between the rotor and the stator tooth and which is formed at least in regions from a soft-magnetic composite material,
wherein the pole shoe is delimited between its side facing the air gap and its side facing the laminated core on at least one side delimiting the pole shoe along a circumferential direction by an obliquely extending surface, and a cross-section of the pole shoe is larger on the side facing the air gap than on the side facing the laminated core.

2. The stator according to claim 1, wherein the stator is a stator of an axial flux machine, so that the pole shoe is arranged on an axial side of the laminated core, wherein the pole shoe is delimited between its side facing the air gap and its side facing the laminated core on at least one side radially delimiting the stator tooth by an obliquely extending surface, wherein the cross-section of the pole shoe on the side facing the air gap is larger than on the side facing the laminated core.

3. The stator according to claim 1, wherein laminations of the laminated core are grain-oriented electrical sheets.

4. The stator according to claim 1, wherein the obliquely extending surface extends up to a maximum of 60% of a height of the pole shoe defined between the laminated core and the air gap.

5. The stator according to claim 1, wherein the stator comprises at least one winding for each stator tooth, which wraps around a respective stator tooth, wherein the pole shoe forms at least one projection along the circumferential direction, which axially covers the winding in regions and extends along the circumferential direction to at least 50% of the maximum distance from the winding to the laminated core.

6. The stator according to claim 1, wherein the stator comprises at least one winding for each stator tooth, which wraps around the respective stator tooth, wherein the pole shoe forms at least one projection along the circumferential direction, which axially covers the winding in regions and extends along the circumferential direction up to 90% of the maximum distance from the winding to the laminated core.

7. The stator according to claim 1, wherein the obliquely extending surface is substantially connected to the laminated core.

8. An electric rotating machine, comprising a stator according to claim 1 and a rotor arranged at the air gap opposite the stator.

9. A geared motor unit, comprising at least one electric rotating machine according to claim 8, and at least one transmission whose transmission input shaft can be coupled to a rotor shaft of the electric rotating machine.
